(19) United States
(12) Patent Application Publication
(10) Pub. No.: US 2024/0391799 A1
(43) Pub. Date: Nov. 28, 2024

(54) SYSTEMS AND METHODS FOR SEPARATION OF RARE EARTH ELEMENTS USING AIR FLOTATION

(71) Applicant: Battelle Memorial Institute, Columbus, OH (US)

(72) Inventors: Slawomir WINECKI, Dublin, OH (US); Emma BRACKMAN, Columbus, OH (US); Devin DICKSON, Columbus, OH (US); Morgan V. EVANS, Columbus, OH (US); Michael HEINRICHS, Dublin, OH (US); Philip KESTER, Midland, MI (US); Stephanie NAPIERALSKI, Columbus, OH (US); James E. RISSER, Lutherville Timonium, MD (US); Hong Be TRUONG, Lewis Center, OH (US)

(73) Assignee: BATELLE MEMORIAL INSTITUTE, Columbus, OH (US)

(21) Appl. No.: 18/671,631

(22) Filed: May 22, 2024

Related U.S. Application Data
(60) Provisional application No. 63/503,604, filed on May 22, 2023.

(51) Int. Cl. C02F 1/24; C02F 101/10; C22B 3/22; C22B 59/00

(52) U.S. Cl. CPC C02F 1/24; C22B 3/22; C22B 59/00; C02F 2101/10; C02F 2301/08; C02F 2305/04

(57) ABSTRACT

A system for the separation of rare earth elements, the system including a separation vessel, the separation vessel including an inlet configured to receive the aqueous solution, an interior configured to house the aqueous solution, where the interior is configured to receive a supply of air; the aqueous solution including one or more rare earth elements, a surfactant, and a complexing agent; a compressed air source, where the compressed air source is operatively coupled to the separation vessel, and configured to propel the supply of air through the aqueous solution; and the supply of air, where the supply of air is operable to induce a plurality of bubbles to form in the aqueous solution, and create a foam layer to form at and above the interface of the aqueous solution, wherein the foam layer comprises the one or more rare earth elements from the aqueous solution.

### CROSS-REFERENCE TO RELATED APPLICATIONS

This application claims priority to U.S. Appl. Ser. No. 63/503,604, filed May 22, 2023, entitled “Systems And Methods For Separation Of Rare Earth Elements Using Air Flotation,” which patent application is commonly owned by the owner of the present invention. This patent application is incorporated herein in its entirety.

### TECHNICAL FIELD

The present disclosure relates to the Rare Earth Elements (“REEs”), which are a naturally occurring set of seventeen metallic elements that may be found in the environment. Specifically, the present disclosure relates to separation of REEs from aqueous solutions using air flotation. The present disclosure relates to separating and recovering REEs based on the use of an improved apparatus, system, and method using air flotation and REE complexation.

### STATEMENT OF FEDERALLY FUNDED RESEARCH

None.

### BACKGROUND

The removal of metal ions from an aqueous medium has long posed a problem when scientists have attempted a targeted removal of specific metal ions. Separation of REEs poses an even more challenging problem, due to the similarity between the chemical properties of REEs, which, in aqueous solutions, form triple charged cations (such as, for example, La³⁺ and Ce³⁺). The separation of rare earth elements (REEs) is particularly challenging because rare earth cations are similar in ionic radius (0.98-1.16 Å) and most often carry a net trivalent charge. Accordingly, the separation, removal, and reuse of rare-earth elements can pose a significant challenge within separation science.

Current means of extracting REEs from mediums present a “pH-swing” mechanism, leading to the consumption of both acid and base throughout the process and generating large quantities of secondary waste products. The management of waste is costly and renders rare-earth separation economically unfeasible in certain countries with strict environmental legislation.

Currently, the most common method for REE separation is liquid-liquid extraction (LLX). These LLX-based REE separation systems are massive in scale, often employing hundreds of separation stages, which increases capital investment requirements and further heightens the problem with economic unfeasibility for REE separation. The large amounts of solvents and hazardous aqueous solutions, such as acids and volatile organics, used in LLX make the process environmentally unfriendly, further increasing the costs.

Furthermore, strong acids used during the extraction process of REEs can leach out into the environment and be transported through water bodies, resulting in the acidification of aquatic environments. The large amounts of solvents and hazardous aqueous solutions used in the current methods and systems for REE separation make the process environmentally unfriendly as well.

Some methods of REE separation research have used complexing agents in conjunction with ion exchange to produce small quantities of high-purity individual REEs. This process, however, was only practiced in small-scale processes due to the incompatibility with commercial needs. REE separation may need to use multiple stages to achieve the targeted level of separation and further purify individual REEs. This separation could be improved if the relative abundance of complexed and uncomplexed rare earth ions could be systematically controlled via the concentration of chelating agents and competing ions in subsequent stages.

Accordingly, there is a need for a cost-effective, environmentally friendly, and scalable system that is designed for the separation of REEs from aqueous solutions.

### SUMMARY OF THE DISCLOSURE

The present disclosure is directed to systems and methods for REE separation using air flotation. The REE separation system includes a compressed air source configured to generate air in a separation vessel containing an aqueous solution of the REEs, a surfactant, and a complexing agent.

To address the need disclosed above, the REE separation system uses a flotation process that allows for efficient mass transfer between the aqueous phase containing REEs and an air phase, which is introduced in form of air bubbles propagated by the compressed air source. In certain embodiments, the efficient mass transfer is accomplished due to the use of air bubbles that small, numerous, and introduced uniformly at the bottom of the separation vessel. In such an embodiment, the air flow combined with the use of a surfactant can generate a foam layer at the top of the solution in the separation vessel.

Accordingly, in certain embodiments, the REE separation system allows for selective adsorption of REEs on the interface between the air and water in the separation vessel. By using air instead of other separation media, such as ion exchange resins or solvents, the system and method of the present disclosure are capable of separating REEs without the large amounts of solvents and hazardous aqueous solutions used in the prior liquid-liquid extraction REE separation methods. As a result, the present disclosure provides a cost effective and environmentally friendly alternative to prior REE separation systems and methods.

In general, in one embodiment, the disclosure features a system for the separation of rare earth elements, the system includes a separation vessel configured to house an aqueous solution. The separation vessel includes an inlet configured to receive the aqueous solution. The separation vessel further includes a base. The separation vessel further includes an interior configured to house the aqueous solution. The system also includes the aqueous solution housed in the interior of the separation vessel. The aqueous solution includes one or more rare earth elements, a surfactant, and a complexing agent. The system also includes a compressed air source. The compressed air source is operatively coupled to the separation vessel. The compressed air source is configured to propel the supply of air through the aqueous solution. The system also includes the supply of air. The supply of air is operable to induce a plurality of bubbles to form in the aqueous solution. The supply of air is further operable to create a foam layer to form at and above the interface of the aqueous solution, wherein the foam layer comprises the one or more rare earth elements from the aqueous solution.

In general, in another embodiment, the disclosure features a method for using air flotation to separate rare earth elements from an aqueous solution. The method includes providing an aqueous solution to an inlet of a separation vessel. The separation vessel has a base, where the separation is operatively coupled to a compressed air source. The separation vessel has an interior configured to house the aqueous solution. The aqueous solution comprises one or more rare earth elements, a surfactant, and a complexing agent. The method further includes introducing the aqueous solution into the interior of the separation vessel. The method further includes introducing air into the interior of the separation vessel. The method further includes, resultant from the introducing air, rising the air through the aqueous solution in the interior of the separation vessel to form gas bubbles. The method further includes, resultant from the formation of gas bubbles, forming a foam layer, where the foam layer is situated atop the aqueous solution, and the foam layer includes at least one of the one or more rare earth elements.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts an REE air-flotation separation system for use with an aqueous solution containing REEs, in accordance with certain embodiments of the present disclosure.

FIG. 2A depicts the chemical structure of an exemplary cationic surfactant for use with the REE air-flotation separation system, in accordance with certain embodiments of the present disclosure.

FIG. 2B depicts the chemical structure of an exemplary anionic surfactant for use with the REE air-flotation separation system, in accordance with certain embodiments of the present disclosure.

FIG. 3A depicts the results of a chemical equilibrium model that simulates reactions between rare earth elements and a complexing agent in the case where the total amount of complexing agent introduced into the solution is not sufficient to complex all REEs, showing the concentration of charged REE-EDTA complexes at various pHs.

FIG. 3B depicts the results of a chemical equilibrium model that simulates reactions between rare earth elements and a complexing agent in the case where the total amount of complexing agent introduced into the solution is not sufficient to complex all REEs, showing the concentration of REE 3+ ions at various pHs.

FIG. 4 depicts a block diagram of a method for using a REE air-flotation separation system to separate REEs from an aqueous solution, in accordance with certain embodiments of the present disclosure.

FIG. 5 depicts working results showing normalized molar concentrations of REE in the remaining solution as a function of time using an anionic surfactant, in accordance with certain embodiments of the present disclosure.

FIG. 6 depicts working results showing normalized molar concentrations of REE in the remaining solution as a function of time using a cationic surfactant, didecyldimethylammonium chloride (DDAC), in accordance with certain embodiments of the present disclosure.

FIG. 7 depicts working results showing normalized molar concentrations of REE in the remaining solution as a function of time using a cationic surfactant, cetyltrimethyl ammonium bromide (CTAB), in accordance with certain embodiments of the present disclosure.

FIG. 8A depicts working results showing mass concentrations of REEs and Fe in the bottoms as a function of time using a surfactant, in accordance with certain embodiments of the present disclosure.

FIG. 8B depicts working results showing normalized molar concentration of REEs and Fe in the bottoms as a function of time using a surfactant, in accordance with certain embodiments of the present disclosure.

FIG. 9A depicts working results showing mass concentrations of REEs in the remaining solution as a function of time using a surfactant, in accordance with certain embodiments of the present disclosure.

FIG. 9B depicts working results showing normalized molar concentration of REEs in the remaining solution as a function of time using a surfactant, in accordance with certain embodiments of the present disclosure.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to” Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

### DETAILED DESCRIPTION OF THE DISCLOSURE

The present disclosure is directed to systems and methods for REE separation using air flotation. The REE separation system includes a compressed air source configured to generate air in a separation vessel containing an aqueous solution of the REEs, a surfactant, and a complexing agent.

The disclosure provides sustainable devices, methods, and systems for the separation of REEs that can help solve the problems of the prior art by introducing a novel method and system for separating REEs from aqueous solutions using air flotation and targeting surfactants, including both anionic and cationic surfactants.

In some embodiments, the REE separation system uses a flotation process that allows for efficient mass transfer between the aqueous phase containing REEs and an air phase, which is introduced in form of air bubbles propagated by the compressed air source. In certain embodiments, the efficient mass transfer is accomplished due to the use of air bubbles that are small, numerous, and introduced uniformly at the bottom of the separation vessel. In such an embodiment, the air flow combined with the use of a surfactant can generate a foam layer at the top of the solution in the separation vessel.

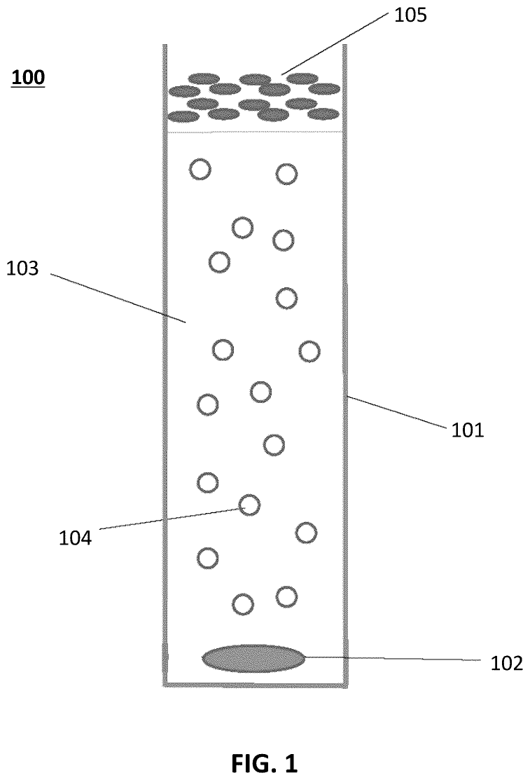

FIG. 1 depicts a schematic of the general REE air-flotation separation system 100 for use with an aqueous solution containing REEs, in accordance with certain embodiments of the present disclosure.

In some embodiments, separation of REE from an aqueous solution may be achieved using air flotation processes that result in the REE being captured in a foam layer situated atop the aqueous solution in a separation column. In such an embodiment, and in accordance with the system 100 shown in FIG. 1, the separation vessel 101 may be coupled to a compressed air source 102 and may house an aqueous solution 103. The separation vessel 101 may include, in certain embodiments, an inlet configured to receive the aqueous solution 103, a base with which the compressed air source 102 is coupled, and an interior that houses the aqueous solution. The aqueous solution 102, in preferred embodiments, can contain one or more REEs as well as a surfactant and complexing agent. In some embodiments, the one or more REEs can be selected from the group consisting of lanthanum, cerium, praseodymium, neodymium, promethium, samarium, europium, gadolinium, terbium, dysprosium, holmium, erbium, thulium, ytterbium, lutetium, scandium, yttrium, and combinations thereof.

The compressed air source 102 may be used to create air bubbles 104 throughout the separation vessel 101. In some embodiments, the compressed air source can be a porous distributor. In other embodiments, the compressed air source can be a nozzle injector. In further embodiments, the compressed air source can be a Venturi pump.

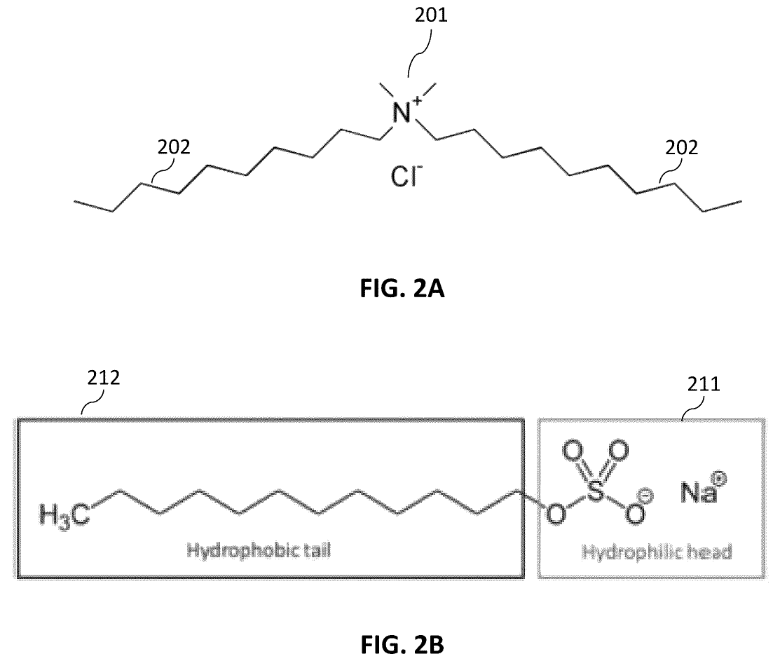

By including a surfactant in the aqueous solution, and as discussed in greater detail in respect to FIGS. 2A-2B, the size of the air bubbles can be reduced in the system. This in turn may increase the surface area of the air-water interface at the top of the separation vessel 101 and increases the effectiveness of the air flotation process employed in the system 100.

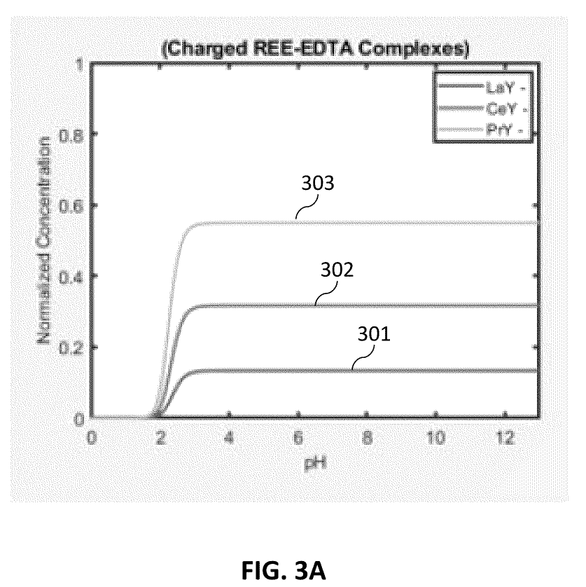

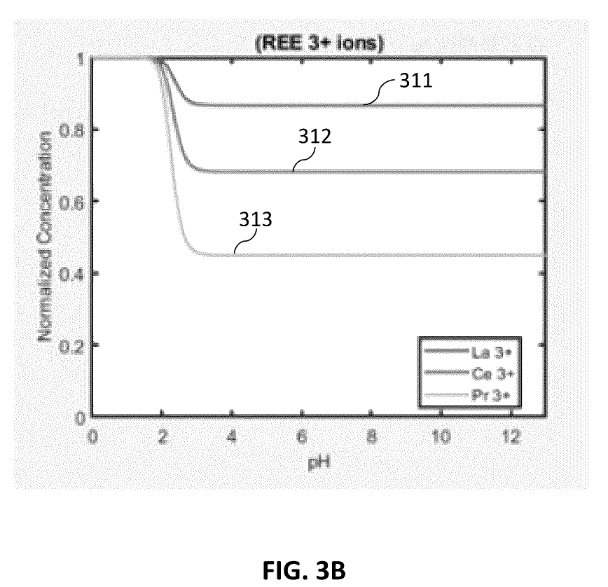

Further, by including the complexing agent, as discussed in greater detail in respect to FIGS. 3A-3B, the complexing agent may bind with a fraction of REE ions present in the solution. In such an embodiment, there can be greater removal of REE ions from the aqueous solution, which can be later extracted as a foam layer 105.

In some embodiments, the separation vessel 101 is a container, cylindrical column, a tank, a vessel, a tube, or combinations thereof. In some embodiments, the separation vessel 101 is a rising foam column. In certain embodiments of the present disclosure, multiples separation vessels may be utilized in order to allow for continuous, multi-stage separation of REEs.

In the embodiment of FIG. 1, the configuration allows for air to rise through of aqueous solution 103. In such an embodiment, as air rises through the aqueous solution 103, air bubbles 104 may be formed. Such bubbles, in this embodiment and as depicted in FIG. 1, allow for the separation of REEs, which will rise to the foam layer 105 building at the air-water interface at the top of the separation vessel 101. In such an embodiment, the foam layer 105 will have an air-water interface with a large surface area. The charged groups on REE ions adsorb to the bubbles of the foam and form a surface layer enriched in REEs that can subsequently be removed.

In some embodiments, the air introduced to the system of FIG. 1 may be compressed air or nitrogen. Further, in some embodiments, the pressure of the container can operate to facilitate the movement of the air bubbles 104 through the aqueous solution 103 to propagate the formation of the foam layer 105. In some embodiments, the foam layer 105 can reflux, and if any foam breaks off, then the portion of the foam layer 105 can be recycled.

The air bubbles 104 allow for the efficient mass transfer between the aqueous phase containing REEs and the air phase. In certain embodiments, the air bubbles 104 can be small, numerous, and introduced uniformly at the bottom of the separation vessel 101. By injecting the air bubbles 104 from the compressed air source 102 at the base of the separation vessel 101, the air bubbles 104 can be let to rise by buoyancy. Accordingly as the air bubbles 104 rise, the air flow combined with the use of appropriate surfactant can cause the generation of the foam layer 105 at the top of the aqueous solution 104.

FIG. 2A depicts the chemical structure of an exemplary cationic surfactant for use with the REE air-flotation separation system, in accordance with certain embodiments of the present disclosure.

In some embodiments, the surfactant that can be used for the REE air-flotation separation system of FIG. 1 is Didecyldimethylammonium chloride (DDAC). DDAC is a cationic surfactant, having a positively charged head 201 and capable of attracting any anionic species that are present in water, such as negatively charged EDTA+REE complexes. In some embodiments, DDAC can be delivered into the aqueous solution as the surfactant. In some embodiments, the DDAC can be delivered into the aqueous solution in conjunction with a chlorine anion. In such an embodiment, the inclusion of both the DDAC and the chlorine anion ensures overall charge neutrality, but still allows the ions to dissociate in aqueous solution.

For example, in certain embodiments, the electrostatic interaction between DDAC's positively charged head and anionic species in water can allow the DDAC to act as a reactant in the REE air-flotation separation process. In order to accomplish this, the DDAC, in such an embodiment, is present in appropriate stoichiometric quantities. For example, the removal of one mole of singly charged anions requires at least one mole of DDAC.

The chemical structure of DDAC, as shown in FIG. 2A, includes a hydrophilic head 201 and two hydrophobic tails 202. Due to the structure including both a hydrophilic head 201 and two hydrophobic tails 202, DDAC will preferentially adsorb at a water-air interface. At such an interface, the hydrophilic head 201 will point towards the water phase. In preferred embodiments, the hydrophobic tails 202 can point towards the air phase.

Accordingly, in some embodiments, because of the head-tail structure of DDAC, there can be a lower surface tension coefficient of the interface. In certain embodiments, equivalently, the DDAC can lead to reduced energy required to increase the surface area of this interface.

In some embodiments, the introduction of DDAC, pictured in FIG. 2A, into the air flotation system, as shown in FIG. 1, can cause the size of air bubbles to be reduced regardless of the type of air distributor used. By reducing the air bubble size, in some embodiments, for a given air flow, the surface area of the air-water interface can be increased. From this, in certain embodiments, the effectiveness of the air flotation process can likewise be increased.

In other embodiments, the REE air-flotation separation system of FIG. 1 may use different cationic surfactants. For example, in some embodiments, the cationic surfactant is selected from the group consisting of didecyldimethylammonium chloride (DDAC), cetyltrimethyl ammonium bromide (CTAB), cetalkonium chloride (CKC), cetylpyridinium chloride (CPC), cocamidopropyl betaine (CAPB), and combinations thereof.

FIG. 2B depicts the chemical structure of an exemplary anionic surfactant for use with the REE air-flotation separation system, in accordance with certain embodiments of the present disclosure.

In some embodiments, the surfactant that can be used for the REE air-flotation separation system of FIG. 1 is sodium dodecyl sulfate (SDS).

The SDS is an anionic surfactant, having a negatively charged head 211 and capable of attracting any cation species that are present in the aqueous solution. In some embodiments, SDS can be delivered into the aqueous solution as the surfactant. In some embodiments, the SDS can be delivered into the aqueous solution in conjunction with a sodium cation. In such an embodiment, the inclusion of both the SDS and the sodium cation ensures overall charge neutrality, but still allows the ions to dissociate in aqueous solution. For example, in an aqueous solution the sodium cations can dissociate and be replaced with other ions, for instance positively charged REE ions or other metal cations.

For example, in certain embodiments, the electrostatic interaction between SDS's negatively charged head and cation species in water can allow the SDS to act as a reactant in the REE air-flotation separation process. In order to accomplish this, the SDS, in such an embodiment, is present in appropriate stoichiometric quantities. For example, the removal of one mole of singly charged cations requires at least one mole of SDS. Similarly, in another embodiment, multiple-charged cations will accordingly require larger amounts of SDS. For example, in such an embodiment, REEs that have a 3+ charge may require at least three moles of SDS per each mole of REE ions.

The chemical structure of SDS, as shown in FIG. 2B, includes a hydrophilic head 211 and a hydrophobic tail 212. Due to the structure including both a hydrophilic head 211 and a hydrophobic tail 212, SDS will preferentially adsorb at a water-air interface. At such an interface, the hydrophilic head 211 will point towards the water phase. In preferred embodiments, the hydrophobic tail 212 can point towards the air phase.

Furthermore, in some embodiments, because of the head-tail structure of SDS, there can be a lower surface tension coefficient of the interface. In certain embodiments, equivalently, the SDS can lead to reduced energy required to increase the surface area of this interface.

In some embodiments, the introduction of SDS, pictured in FIG. 2B, into the air flotation system, as shown in FIG. 1, can cause the size of air bubbles to be reduced regardless of the type of air distributor used. By reducing the air bubble size, in some embodiments, for a given air flow, the surface area of the air-water interface can be increased. From this, in certain embodiments, the effectiveness of the air flotation process can likewise be increased.

In other embodiments, the REE air-flotation separation system of FIG. 1 may use a different cationic surfactants. For example, in some embodiments, the cationic surfactant is selected from the group consisting of cetyltrimethyl ammonium bromide (CTAB), other quaternary ammonium salts, ammonium or sodium lauryl sulfate, sodium laureth sulfate, dimethyldioctadecylammonium bromide and combinations thereof.

In some embodiments, the system 100 of FIG. 1 may include an aqueous solution 103 containing more than one surfactant. In some embodiments, the surfactant may be electrochemically neutral.

As both anionic and cationic surfactants can be utilized with the system 100 of FIG. 1, it can be highly important to ensure that the system is operating a pH that allows for the separation of the REEs and formation of the foam layer. For example, each complexing agent and surfactant combination will require proper pH and concentration conditions to manage the overall system chemistry.

FIG. 3A depicts the results of a chemical equilibrium model that simulates reactions between rare earth elements and a complexing agent in the case where the total amount of complexing agent introduced into the solution is not sufficient to complex all REEs, showing the concentration of charged REE-EDTA complexes at various pHs. FIG. 3B depicts the results of a chemical equilibrium model that simulates reactions between rare earth elements and a complexing agent in the case where the total amount of complexing agent introduced into the solution is not sufficient to complex all REEs, showing the concentration of REE 3+ ions at various pHs.

In some embodiments, air flotation of REEs in the presence of a surfactant by itself may not be selective for individual REE elements, since chemical and physical properties of REEs may be simply too comparable. However, in certain embodiments, such selectivity can be provided by introduction of complexing agents that bind with a fraction of REE ions present in the solution.

Accordingly, in some embodiments, the aqueous solution includes complexing agents having complexing equilibrium constants that are sufficiently different from specific REE elements to allow for the separation of such REEs. For example, the complexing agent can be selected from the group consisting of ethylenediaminetetraacetic acid (EDTA), hydroxy ethylethylenediaminetriacetic acid (HEDTA), nitrilotriacetic acid (NTA), diethylene-triaminepentaacetic acid (DTPA), N,N′-ethylenediaminedisuccinic acid (EDDS), iminodisuccinic acid (IDS), polyaspartic acid (PASA), N,N-bis(carboxylmethyl)-L-glutamic acid (GLDA), methylglycinediacetic acid (MGDA), hydroxyethyliminodiacetic acid (HEIDA), and combinations thereof.

The complexation equilibria between REEs and EDTA can be modeled. FIGS. 3A-3B show results of a chemical equilibrium model that simulates reactions between certain REEs-specifically, Lanthanum (La), Cerium (Ce), and Praseodymium (Pr) and a complexing agent (EDTA, denoted as “Y” in FIG. 3A). As shown in FIGS. 3A and 3B, when the total amount of complexing agent introduced into the solution is not sufficient to complexate all REEs, the result can be a partial complexation case.

In the example of FIGS. 3A-3B, the REEs were at a concentration of 10-4 molar and the complexing agent was at a concentration of 10-4 molar.

As shown by FIGS. 3A-3B, the simulation predicts significant concentration differences over a broad pH range, specifically for all pH levels above approximately 3. As shown by FIGS. 3A-3B, the relative concentrations of EDTA-complexated anions (LaY⁻301, CeY⁻302, and PrY⁻303, as shown in FIG. 3A) and bare REE cations (La³⁺311, Ce³⁺312, and Pr³⁺313, as shown in FIG. 3B) can be substantially different. For example, the concentration of PrY was shown to be approximately four times larger than the concentration of LaY⁻, even though the initial concentration of both elements were identical.

As shown by the comparison of FIGS. 3A and 3B, the relative concentrations of bare REE cations and EDTA-complexated anions have opposite trends, PrY dominates among complexated ions while La³⁺ dominates among bare ions. Since the two families of ions have opposite electric charge, charged surfactants will bind only with one of these families. The air flotation process with SDS will affect bare REE 3+ ions, which according to FIG. 3B, will preferentially remove La³⁺. In such an embodiment, the foam phase on the air flotation process will be rich La³⁺ while the remaining solution will be rich with Pr³⁺.

The partial complexation separation scheme as shown in FIGS. 3A-3B would likewise apply to other REEs. In fact, the three REEs shown in FIGS. 3A-3B represent some of the most challenging separation cases because there are neighbors on the periodic table (atomic numbers 57, 58, 59). In certain embodiments, elements with further apart periodic numbers will be easier to separate.

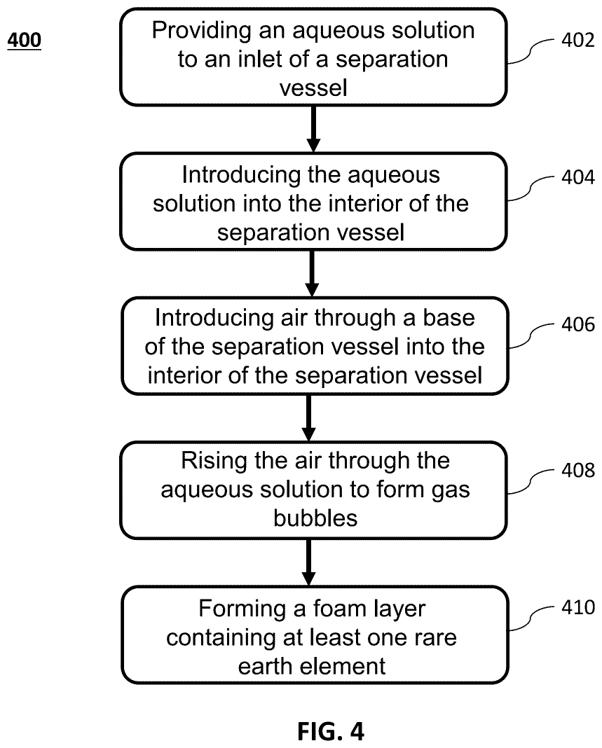

Referring to FIG. 4, which depicts a block diagram of a method for using a method for using air flotation to separate rare earth elements from an aqueous solution. The method 400 may be initiated by preparing an aqueous solution containing REEs, a surfactant, and a complexing agent.

As shown in FIG. 4, method 400 beings at step 402. At step 402, the method includes providing an aqueous solution to an inlet of a separation vessel. In some embodiments, the feed stream can include a PFAS contaminant. In some embodiments, the separation vessel may have a base. In some embodiments, the base may be operatively coupled to a compressed air source. In certain embodiments, the separation vessel has an interior configured to house the aqueous solution. In certain embodiments, the aqueous solution comprises one or more rare earth elements, a surfactant, and a complexing agent.

At step 404, the method includes introducing the aqueous solution into the interior of the separation vessel. For example, in such an embodiment, the aqueous solution can be housed within a separation vessel to allow for separation. At step 406, the method includes introducing air through the base of the separation vessel into the interior of the separation vessel. The air, in certain embodiments, may be compressed air.

At step 408, the method includes, as a result of introducing air into the base of the separation vessel, rising the air through the aqueous solution in the interior of the separation vessel to form gas bubbles.

At step 410, as a result of the gas bubbles in the aqueous solution, the method includes forming a foam layer. In some embodiments, the foam layer is situated atop the aqueous solution in the interior of the separation vessel. In certain embodiments, the foam layer can include at least one or more REEs that were initially present in the aqueous solution. After the foam layer is formed, a multi-stage process can be used continuously to remove the REEs still remaining in the aqueous solution. In certain embodiments, the process may use a titration method for separation. For example, in such a process, the process reagents, complexing agent, and/or the surfactant may be sequentially added into a separation vessel. In some embodiments, the method 400 can also include collecting the foam layer. In some embodiments, the method 400 can also include refluxing the foam layer.

In some embodiments, Fe³⁺ may be utilized to perform partial decomplexation of the liquid fraction that remains after air flotation processing. EDTA preferentially binds Fe³⁺>>Pr³⁺>Ce³⁺>La³⁺. In such an embodiment, due to its high formation constant (Kf), adding Fe³⁺ to the liquid fraction results in the displacement of REEs from complexes in the opposite order of their Kf values. Therefore, in such an embodiment, adding Fe³⁺ in a concentration less than the total concentration of complexed REEs, analogous to the EDTA restriction method used in partial chelation, should result in the preferential displacement of La³⁺ and Ce³⁺ from EDTA relative to Pr³⁺, leaving primarily Pr³⁺ and Fe³⁺ complexes behind. The partial decomplexation may be utilized with all REEs, with REEs located further apart on the periodic table separating with greater ease due to the differences in relative affinity to bind to EDTA.

In such an embodiment, the method and system allow for further removal of La³⁺ and Ce³⁺ ions by flotation. In certain embodiments, only the liquid fraction that remains after air flotation will need to be partially decomplexed. Because, in such embodiments, the foamate is enriched in bare REE ions, the foamate may be treated in a similar manner to the original starting solution, as discussed in respect to FIG. 4. In such an embodiment, as the solution already contains surfactant, the surfactant may be added only when the foam generation ceases.

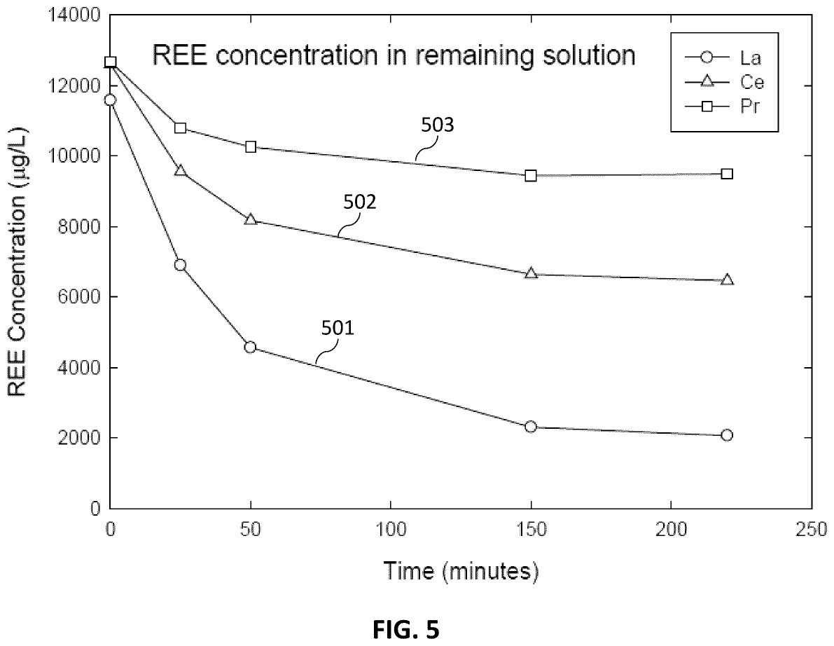

FIG. 5 depicts working results showing normalized molar concentrations of REE in the remaining solution as a function of time using an anionic surfactant, in accordance with certain embodiments of the present disclosure.

Working Example 1: The REE separation scheme as described in FIG. 1 was confirmed experimentally using aqueous solution containing La, Ce, and Pr at 10-4 molar, EDTA added at 10-4 molar, and SDS added at 6×10−4 molar concentrations. In this working example embodiment, one liter of such solution was processed in the air flotation system using continuous air flow of 100 ml per minute. In this exemplary embodiment, the pH of the solution was about 3.98. The remaining solution was sampled at several times and analyzed for REE content using the ICPMS method. FIG. 5 shows the evolution of REE concentrations with time. It is apparent that this process preferentially removes La 501, leaves most of Pr 502 in solution, while Ce 503 is removed with intermediate rate. As shown by FIG. 5, clear elemental separation was visible after 20 minutes of air flotation, and the system approached completion after about 150 minutes.

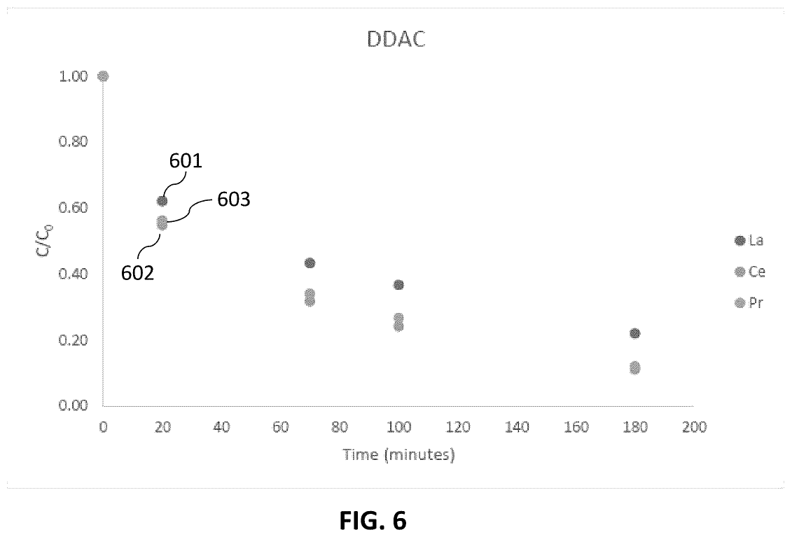

FIG. 6 depicts working results showing normalized molar concentrations of REE in the remaining solution as a function of time using a cationic surfactant, didecyldimethylammonium chloride (DDAC), in accordance with certain embodiments of the present disclosure.

Working Example 2: The REE separation scheme as described in FIG. 1 was confirmed experimentally using aqueous solution containing La, Ce, and Pr at 10-4 molar, EDTA added at 10-4 molar, and DDAC added at 10-4 molar concentrations. In this working example embodiment, one liter of such solution was processed in the air flotation system using continuous air flow of 100 ml per minute and a pH adjusted to about 12 (using NaOH). In the embodiment, the remaining solution was sampled at several time points and analyzed for REE content using the ICP-MS method. As shown by FIG. 6, which depicts the evolution of REE concentrations in the remaining over time, the process preferentially removes Pr 602 and Ce 603 but leaves a significantly larger amount of La 601 behind. As shown by FIG. 6, clear elemental separation was visible after 20 minutes of air flotation.

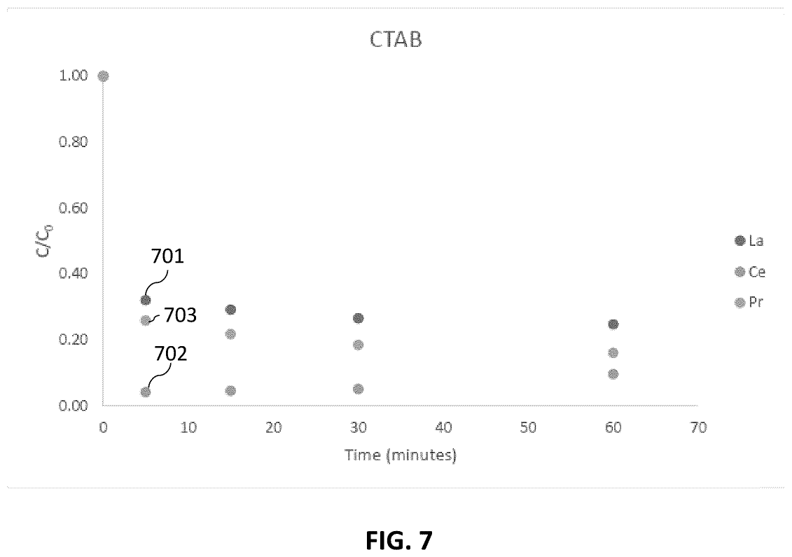

FIG. 7 depicts working results showing normalized molar concentrations of REE in the remaining solution as a function of time using a cationic surfactant, cetyltrimethyl ammonium bromide (CTAB), in accordance with certain embodiments of the present disclosure.

Working Example 3: The REE separation scheme as described in FIG. 1 was confirmed experimentally using aqueous solution containing La, Ce, and Pr at 10-4 molar, EDTA added at 10-4 molar, and CTAB added at 10-4 molar concentrations. In this working example embodiment, one liter of such solution was processed in the air flotation system using continuous air flow of 100 ml per minute and a pH adjusted to about 12 (using NaOH). In the embodiment, the remaining solution was sampled at several time points and analyzed for REE content using the ICP-MS method. As shown by FIG. 6, which depicts the evolution of REE concentrations in the remaining over time, the process preferentially removes Pr 702 and Ce 703 but leaves a larger amount of La 701 behind. As shown by FIG. 7, clear elemental separation was visible after 20 minutes of air flotation.

Working Example 4: The partial decomplexation scheme was confirmed experimentally using an aqueous solution containing 10-4 molar each of La, Ce, Pr, and EDTA. In the embodiment of this working example, sodium dodecyl sulfate (SDS) was added at a 3:1 SDS: REE molar ratio, and the pH of the solution was adjusted to ˜4 using HCl. Further, in this working example, a total volume of 1.8 L of solution was processed in the air flotation system using a continuous air flow of 100 mL per minute. At the conclusion of the experiment, the remaining solution (i.e., the bottoms) was sampled and analyzed for REE content using ICP-MS. Table 1 shows the fractional removal of La, Ce, and Pr from the bottoms after air flotation.

| | Initial | Final | Fractional |
|---|---|---|---|
| Element | Concentration (μg/L) | Concentration (μg/L) | Removal (%) |
| La | 8949 | 873 | 90 |
| Ce | 10630 | 4146 | 61 |
| Pr | 11802 | 7749 | 34 |

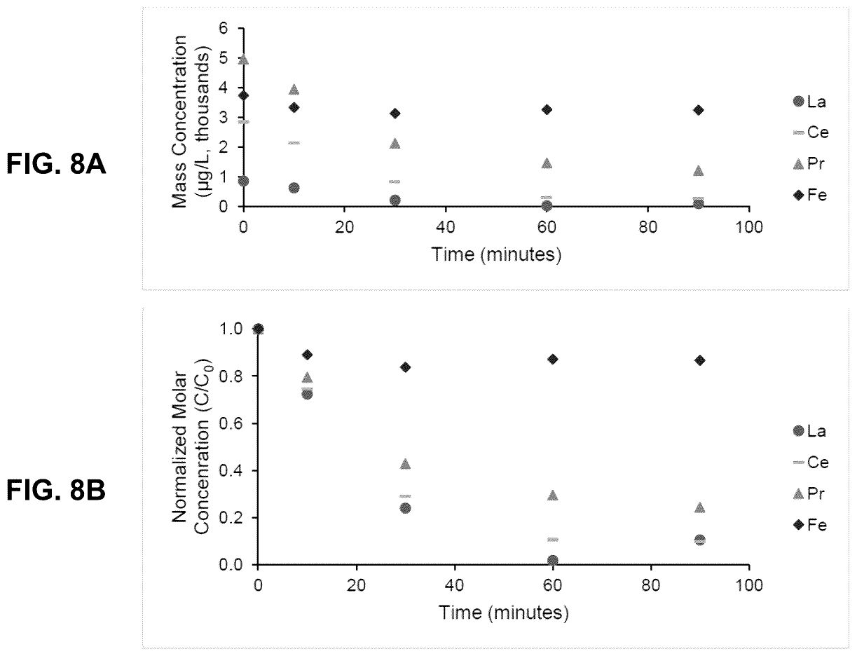

As shown in Table 1, above, this working example embodiment depicts significant separation between La, Ce, and Pr. In the working example embodiment, Fe (III) chloride was added to the bottoms described in Table 1 in the same molar concentration as La and Ce. In this embodiment, SDS was added at a 3:1 SDS to REE molar ratio, and water was added until the total solution volume was 1.8 L. The solution was processed in the air flotation system using a continuous air flow of 100 mL per minute. After approximately 60 minutes, foaming ceased, so 8 mL of 10 g/L SDS solution was added. FIGS. 8A and 8B depict the evolution of REE concentrations in the bottoms over time.

FIG. 8A depicts working results showing mass concentrations of REEs and Fe in the bottoms as a function of time using a surfactant. FIG. 8B depicts working results showing normalized molar concentration of REEs and Fe in the bottoms as a function of time using a surfactant. FIGS. 8A and 8B demonstrate that Fe³⁺ primarily remains in the bottoms (>80%), consistent with EDTA complexation, and that REEs have been displaced. As observed in previous experiments, La³⁺ and Ce³⁺ are shown to be preferentially depleted from solution.

In working example 4, the foamate corresponding to the solution in FIGS. 8A and 8B was also separated further. In this working example, the water was added to the foamate to increase the volume to 1.8 L, and EDTA was added to equal the concentration of Pr³⁺. Initially, in this working example, additional SDS was not added. Rather, in the embodiment of this working example, the solution was processed in the air flotation system using a continuous air flow of 100 mL per minute.

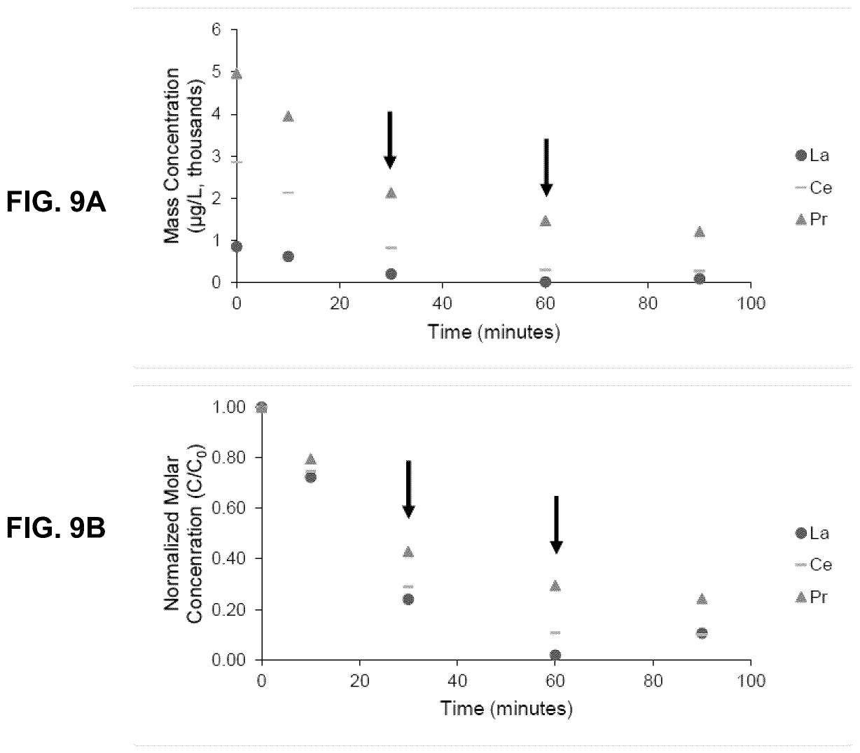

FIG. 9A depicts working results showing mass concentrations of REEs in the remaining solution as a function of time using a surfactant. FIG. 9B depicts working results showing normalized molar concentration of REEs in the remaining solution as a function of time using a surfactant.

FIGS. 9A and 9B show the evolution of REE concentrations in the solution over time. As shown in FIGS. 9A and 9B, at both 25 and 60 minutes (indicated by arrows), 10 mL of 10 g/L SDS solution was added to generate foam. Notably, FIGS. 9A and 9B demonstrate that La³⁺ was nearly completely depleted from the solution after 60 minutes.

Table 2 provides a model simulating partial decomplexation using Fe. As shown in Table 2 below, the results of a chemical equilibrium model that simulates reactions between La, Ce, Pr, Fe, and EDTA and emulates the experiments represented in Table 1 and FIGS. 8A and 8B.

| | Initial | Final | Bottoms Concentration |
|---|---|---|---|
| | Concentration | Concentration | After Partial |
| Element | (μM) | (μM) | Decomplexation (μM) |
| Fe | 0.0 | 0.0 | 21.1 |
| La | 64.4 | 8.7 | 1.3 |
| Ce | 75.9 | 22.1 | 6.9 |
| Pr | 83.8 | 37.9 | 17.8 |

For comparison, the results of these experiments are tabulated in Table 3 below. The experimental results follow the trends predicted by the chemical equilibrium model.

| | Initial | Final | Bottoms Concentration |
|---|---|---|---|
| | Concentration | Concentration | After Partial |
| Element | (μM) | (μM) | Decomplexation (μM) |
| Fe | 0.0 | 0.0 | 58.1 |
| La | 64.4 | 6.3 | 0.6 |
| Ce | 75.9 | 29.6 | 2.0 |
| Pr | 83.8 | 55.0 | 8.6 |

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.

Clause 1. A system for the separation of rare earth elements, the system including a separation vessel configured to house an aqueous solution, the separation vessel including an inlet configured to receive the aqueous solution, a base, and an interior configured to house the aqueous solution, where the interior is configured to receive a supply of air; the aqueous solution housed in the interior of the separation vessel, the aqueous solution including one or more rare earth elements, a surfactant, and a complexing agent; a compressed air source, where the compressed air source is operatively coupled to the separation vessel, and configured to propel the supply of air through the aqueous solution; and the supply of air, where the supply of air is operable to induce a plurality of bubbles to form in the aqueous solution, and create a foam layer to form at and above the interface of the aqueous solution, where the foam layer comprises the one or more rare earth elements from the aqueous solution.

Clause 2. The system of any foregoing clause, where the one or more rare earth elements are selected from the group consisting of lanthanum, cerium, praseodymium, neodymium, promethium, samarium, europium, gadolinium, terbium, dysprosium, holmium, erbium, thulium, ytterbium, lutetium, scandium, yttrium, and combinations thereof.

Clause 3. The system of any foregoing clause, where the surfactant is a cationic surfactant.

Clause 4. The system of any foregoing clause, where the cationic surfactant is selected from the group consisting of didecyldimethylammonium chloride (DDAC), cetyltrimethyl ammonium bromide (CTAB), cetalkonium chloride (CKC), cetylpyridinium chloride (CPC), cocamidopropyl betaine (CAPB), and combinations thereof.

Clause 5. The system of any foregoing clause, where the cationic surfactant is didecyldimethylammonium chloride (DDAC).

Clause 6. The system of any foregoing clause, where the aqueous solution further comprises a chlorine anion.

Clause 7. The system of any foregoing clause, where the surfactant is an anionic surfactant.

Clause 8. The system of any foregoing clause, where the anionic surfactant is selected from the group consisting of sodium dodecyl sulfate (SDS), cetyltrimethyl ammonium bromide (CTAB), a quaternary ammonium salt, ammonium lauryl sulfate, sodium lauryl sulfate, sodium laureth sulfate, dimethyldioctadecylammonium bromide, and combinations thereof.

Clause 9. The system of any foregoing clause, where the anionic surfactant is sodium dodecyl sulfate (SDS).

Clause 10. The system of any foregoing clause, where the aqueous solution further comprises a sodium cation.

Clause 11. The system of any foregoing clause, where the aqueous solution further comprises a second surfactant.

Clause 12. The system of any foregoing clause, where the complexing agent is selected from the group consisting of ethylenediaminetetraacetic acid (EDTA), hydroxy ethylethylenediaminetriacetic acid (HEDTA), nitrilotriacetic acid (NTA), diethylene-triaminepentaacetic acid (DTPA), N,N′-ethylenediaminedisuccinic acid (EDDS), iminodisuccinic acid (IDS), polyaspartic acid (PASA), N,N-bis(carboxylmethyl)-L-glutamic acid (GLDA), methylglycinediacetic acid (MGDA), hydroxyethyliminodiacetic acid (HEIDA), and combinations thereof.

Clause 13. The system of any foregoing clause, where the compressed air source is selected from the group consisting of a porous distributor, a nozzle injector, and a Venturi pump.

Clause 14. The system of any foregoing clause, where separation vessel is a rising foam column.

Clause 15. A method for using air flotation to separate rare earth elements from an aqueous solution, the method including providing an aqueous solution to an inlet of a separation vessel, where the separation vessel has a base, where the separation vessel is operatively coupled to a compressed air source, the separation vessel has an interior configured to house the aqueous solution, and the aqueous solution includes one or more rare earth elements, a surfactant, and a complexing agent; introducing the aqueous solution into the interior of the separation vessel; introducing air into the interior of the separation vessel; resultant from the introducing air, rising the air through the aqueous solution in the interior of the separation vessel to form gas bubbles; and resultant from the formation of gas bubbles, forming a foam layer, where the foam layer is situated atop the aqueous solution, and the foam layer includes at least one of the one or more rare earth elements.

Clause 16. The method of any foregoing clause further including repeating steps (a) through (e) in a multi-stage process.

Clause 17. The method of any foregoing clause further including collecting the foam layer.

Clause 18. The method of any foregoing clause further including refluxing the foam layer.

Clause 19. The method of any foregoing clause, where the one or more rare earth elements are selected from the group consisting of lanthanum, cerium, praseodymium, neodymium, promethium, samarium, europium, gadolinium, terbium, dysprosium, holmium, erbium, thulium, ytterbium, lutetium, scandium, yttrium, and combinations thereof.

Clause 20. The method of any foregoing clause, where the surfactant is a cationic surfactant.

Clause 21. The method of any foregoing clause, where the cationic surfactant is selected from the group consisting of didecyldimethylammonium chloride (DDAC), cetyltrimethyl ammonium bromide (CTAB), cetalkonium chloride (CKC), cetylpyridinium chloride (CPC), cocamidopropyl betaine (CAPB), and combinations thereof.

Clause 22. The method of any foregoing clause, where the cationic surfactant is didecyldimethylammonium chloride (DDAC).

Clause 23. The method of any foregoing clause, where the aqueous solution further comprises a chlorine anion.

Clause 24. The method of any foregoing clause, where the surfactant is an anionic surfactant.

Clause 25. The method of any foregoing clause, where the anionic surfactant is selected from the group consisting of sodium dodecyl sulfate (SDS), cetyltrimethyl ammonium bromide (CTAB), a quaternary ammonium salt, ammonium lauryl sulfate, sodium lauryl sulfate, sodium laureth sulfate, dimethyldioctadecylammonium bromide, and combinations thereof.

Clause 26. The method of any foregoing clause, where the anionic surfactant is sodium dodecyl sulfate (SDS).

Clause 27. The method of any foregoing clause, where the aqueous solution further comprises a sodium cation.

Clause 28. The method of any foregoing clause, where the aqueous solution further comprises a second surfactant.

Clause 29. The method of any foregoing clause, where the complexing agent is selected from the group consisting of ethylenediaminetetraacetic acid (EDTA), hydroxy ethylethylenediaminetriacetic acid (HEDTA), nitrilotriacetic acid (NTA), diethylene-triaminepentaacetic acid (DTPA), N,N′-ethylenediaminedisuccinic acid (EDDS), iminodisuccinic acid (IDS), polyaspartic acid (PASA), N,N-bis(carboxylmethyl)-L-glutamic acid (GLDA), methylglycinediacetic acid (MGDA), hydroxyethyliminodiacetic acid (HEIDA), and combinations thereof.

Clause 30. The method of any foregoing clause, where the compressed air source is selected from the group consisting of a porous distributor, a nozzle injector, and a Venturi pump.

Clause 31. The method of any foregoing clause, where the separation vessel is a rising foam column.

### REFERENCES

Nunes, A.I.V., L. Muhr, and F. Lapicque, Ion Transport Phenomena in Focalisation Electrophoresis Processes for the Separation of Rare Earth Metals. ICHEME Symposium Series, 1999. 145.
Morel, F.M.M. and J.G. Hering, Principles and Applications of Aquatic Chemistry. 1993: John Wiley & Sons, Inc.
Smith, D.S., Solution of Simultaneous Chemical Equilibria in Heterogeneous System: Implementation in Matlab, in Chemistry Faculty Publications 2019, Wilfrid Laurier University.

What is claimed is:

1. A system for the separation of rare earth elements, the system comprising:
(a) a separation vessel configured to house an aqueous solution, the separation vessel comprising:
(i) an inlet configured to receive the aqueous solution, (ii) a base, and
(iii) an interior configured to house the aqueous solution, wherein the interior is configured to receive a supply of air;
(b) the aqueous solution housed in the interior of the separation vessel, the aqueous solution comprising:
(i) one or more rare earth elements,
(ii) a surfactant, and
(iii) a complexing agent;
(c) a compressed air source, wherein the compressed air source is
(i) operatively coupled to the separation vessel, and
(ii) configured to propel the supply of air through the aqueous solution; and
(d) the supply of air, wherein the supply of air is operable to
(i) induce a plurality of bubbles to form in the aqueous solution, and
(ii) create a foam layer to form at and above the interface of the aqueous solution, wherein the foam layer comprises the one or more rare earth elements from the aqueous solution.

2. The system of claim 1, wherein the one or more rare earth elements are selected from the group consisting of lanthanum, cerium, praseodymium, neodymium, promethium, samarium, europium, gadolinium, terbium, dysprosium, holmium, erbium, thulium, ytterbium, lutetium, scandium, yttrium, and combinations thereof.

3. The system of claim 1, wherein the surfactant is a cationic surfactant.

4. The system of claim 3, wherein the cationic surfactant is selected from the group consisting of didecyldimethylammonium chloride (DDAC), cetyltrimethyl ammonium bromide (CTAB), cetalkonium chloride (CKC), cetylpyridinium chloride (CPC), cocamidopropyl betaine (CAPB), and combinations thereof.

5. The system of claim 4, wherein the cationic surfactant is didecyldimethylammonium chloride (DDAC).

6. The system of claim 5, wherein the aqueous solution further comprises a chlorine anion.

7. The system of claim 1, wherein the surfactant is an anionic surfactant.

8. The system of claim 7, wherein the anionic surfactant is selected from the group consisting of sodium dodecyl sulfate (SDS), cetyltrimethyl ammonium bromide (CTAB), a quaternary ammonium salt, ammonium lauryl sulfate, sodium lauryl sulfate, sodium laureth sulfate, dimethyldioctadecylammonium bromide, and combinations thereof.

9. The system of claim 8, wherein the anionic surfactant is sodium dodecyl sulfate (SDS).

10. The system of claim 9, wherein the aqueous solution further comprises a sodium cation.

11. The system of claim 1, wherein the aqueous solution further comprises a second surfactant.

12. The system of claim 1, wherein the complexing agent is selected from the group consisting of ethylenediaminetetraacetic acid (EDTA), hydroxy ethylethylenediaminetriacetic acid (HEDTA), nitrilotriacetic acid (NTA), diethylene-triaminepentaacetic acid (DTPA), N,N′-ethylenediaminedisuccinic acid (EDDS), iminodisuccinic acid (IDS), polyaspartic acid (PASA), N,N-bis(carboxylmethyl)-L-glutamic acid (GLDA), methylglycinediacetic acid (MGDA), hydroxyethyliminodiacetic acid (HEIDA), and combinations thereof.

13. The system of claim 1, wherein the compressed air source is selected from the group consisting of a porous distributor, a nozzle injector, and a Venturi pump.

14. The system of claim 1, wherein separation vessel is a rising foam column.

15. A method for using air flotation to separate rare earth elements from an aqueous solution, the method comprising:
(a) providing an aqueous solution to an inlet of a separation vessel, wherein
(i) the separation vessel has a base, wherein the separation vessel is operatively coupled to a compressed air source,
(ii) the separation vessel has an interior configured to house the aqueous solution, and
(iii) the aqueous solution comprises one or more rare earth elements, a surfactant, and a complexing agent;
(b) introducing the aqueous solution into the interior of the separation vessel;
(c) introducing air into the interior of the separation vessel;
(d) resultant from the introducing air, rising the air through the aqueous solution in the interior of the separation vessel to form gas bubbles; and
(e) resultant from the formation of gas bubbles, forming a foam layer, wherein
(i) the foam layer is situated atop the aqueous solution, and
(ii) the foam layer comprises at least one of the one or more rare earth elements.

16. The method of claim 15 further comprising repeating steps (a) through (e) in a multi-stage process.

17. The method of claim 15 further comprising collecting the foam layer.

18. The method of claim 15 further comprising refluxing the foam layer.

19. The method of claim 15, wherein the one or more rare earth elements are selected from the group consisting of lanthanum, cerium, praseodymium, neodymium, promethium, samarium, europium, gadolinium, terbium, dysprosium, holmium, erbium, thulium, ytterbium, lutetium, scandium, yttrium, and combinations thereof.

20. The method of claim 15, wherein the surfactant is a cationic surfactant.

21. The method of claim 20, wherein the cationic surfactant is selected from the group consisting of didecyldimethylammonium chloride (DDAC), cetyltrimethyl ammonium bromide (CTAB), cetalkonium chloride (CKC), cetylpyridinium chloride (CPC), cocamidopropyl betaine (CAPB), and combinations thereof.

22. The system of claim 21, wherein the cationic surfactant is didecyldimethylammonium chloride (DDAC).

23. The system of claim 22, wherein the aqueous solution further comprises a chlorine anion.

24. The system of claim 15, wherein the surfactant is an anionic surfactant.

25. The system of claim 24, wherein the anionic surfactant is selected from the group consisting of sodium dodecyl sulfate (SDS), cetyltrimethyl ammonium bromide (CTAB), a quaternary ammonium salt, ammonium lauryl sulfate, sodium lauryl sulfate, sodium laureth sulfate, dimethyldioctadecylammonium bromide, and combinations thereof.

26. The system of claim 25, wherein the anionic surfactant is sodium dodecyl sulfate (SDS).

27. The system of claim 26, wherein the aqueous solution further comprises a sodium cation.

28. The system of claim 15, wherein the aqueous solution further comprises a second surfactant.

29. The system of claim 15, wherein the complexing agent is selected from the group consisting of ethylenediaminetetraacetic acid (EDTA), hydroxy ethylethylenediaminetriacetic acid (HEDTA), nitrilotriacetic acid (NTA), diethylene-triaminepentaacetic acid (DTPA), N,N′-ethylenediaminedisuccinic acid (EDDS), iminodisuccinic acid (IDS), polyaspartic acid (PASA), N,N-bis(carboxylmethyl)-L-glutamic acid (GLDA), methylglycinediacetic acid (MGDA), hydroxyethyliminodiacetic acid (HEIDA), and combinations thereof.

30. The system of claim 15, wherein the compressed air source is selected from the group consisting of a porous distributor, a nozzle injector, and a Venturi pump.

31. The system of claim 15, wherein separation vessel is a rising foam column.
